(19) United States
(12) Patent Application Publication
(10) Pub. No.: US 2013/0254444 A1
(43) Pub. Date: Sep. 26, 2013

(54) IMAGE PROCESSING APPARATUS

(71) Applicant: Yoshikazu GYOBU, Kanagawa (JP)

(72) Inventor: Yoshikazu GYOBU, Kanagawa (JP)

(73) Assignee: RICOH COMPANY, LTD.

(21) Appl. No.: 13/798,719

(22) Filed: Mar. 13, 2013

(30) Foreign Application Priority Data
Mar. 23, 2012 (JP) 2012-066677

(51) Int. Cl. G06F 13/364

(52) U.S. Cl. CPC G06F 13/364
USPC 710/110

(57) ABSTRACT

An image processing apparatus capable of controlling data transmission between a plurality of bus masters and a memory, includes a bandwidth-limitation storing unit which calculates a memory bandwidth-limitation setting value for each of the bus masters corresponding to the combination of the operating statuses of the bus masters based on a bandwidth-limitation table which stores memory bandwidth-limitation setting values of the bus masters, respectively, for each of the combinations of the operating statuses of the bus masters; a bus adjustment unit connected between the plurality of bus masters and the memory, which limits the data transmission for a bus master whose memory bandwidth occupancy ratio obtained by monitoring the operating statuses of the bus masters, reaches a respective set memory bandwidth-limitation setting value; and a control unit which dynamically sets the calculated memory bandwidth-limitation setting value for each of the bus masters in the bus adjustment unit.

### BACKGROUND OF THE INVENTION

1. Field of the Invention

The present invention relates to an image processing apparatus capable of adjusting data transmission to a memory.

2. Description of the Related Art

In an image processing apparatus such as a printer or the like, an Application Specific Integrated Circuit (ASIC) is mounted for performing image processing by hardware.

In an image processing apparatus in which a main memory is aggregated on a custom chip such as the ASIC or the like, various transmissions are concentrated in the memory. Examples of the transmissions are “engine transmission”, “image processing transmission”, “CPU transmission”, “IO transmission” or the like. The “engine transmission” is typically used for a scanner, a plotter or the like, and isochronous use for a line unit is required. The “image processing transmission” is typically used for a HDD, a compressing and expanding, a rotation, and isochronous use for a page unit is required. In the “CPU transmission”, performance as a system is required. The “IO transmission” is typically used for a network or USB, and a performance as an external Interface (IF) is required.

Here, a usable bandwidth at a memory side is limited. Thus, a technique which satisfies requirements of various transmissions by adding a bandwidth-limitation function in addition to adding a priority in transmission in a memory arbiter or a memory controller has been considered and known.

For example, in Patent Document 1, a structure is disclosed in which a bandwidth for a peripheral transmission whose priority is lower is retained. In this structure, counters for measuring access time to the memory by plural units such as “engine transmission”, “image processing transmission” or the like are provided in a bus adjustment unit. Then, the priority is changed or an access request is not accepted based on the comparison between the measured counter value and a predetermined set value, for each of the units.

However, in a conventional memory controller with the bandwidth-limitation function, the bandwidth-limitation is only statically provided. Specifically, for example, when a predetermined bandwidth-limitation is provided for the engine transmission, the bandwidth for the engine transmission cannot be used by the transmissions other than the engine transmission even when the engine transmission is not being performed. With this structure, the memory bandwidth for the engine transmission becomes useless, and the memory bandwidth cannot be effectively used in accordance with the data transmission status.

For example, in Patent Document 1, when the counter of the CPU transmission reaches the set value, an access request by the CPU cannot be accepted. As a result, the memory bandwidth cannot be used even if there is room in the memory bandwidth so that the memory bandwidth cannot be effectively used.

### PATENT DOCUMENT

[Patent Document 1] Japanese Laid-open Patent Publication No. 2005-56239

### SUMMARY OF THE INVENTION

The present invention is made in light of the above problems, and provides an image processing apparatus capable of dynamically setting memory bandwidth-limitation setting values of a plurality of bus masters.

According to an embodiment, there is provided an image processing apparatus capable of controlling data transmission including image data between a plurality of bus masters and a memory, including a bandwidth-limitation storing unit which calculates a memory bandwidth-limitation setting value for each of the bus masters corresponding to the combination of the operating statuses of the bus masters obtained as a result of monitoring the operating statuses of the bus masters based on a bandwidth-limitation table which stores memory bandwidth-limitation setting values of the bus masters, respectively, for each of the combinations of the operating statuses of the bus masters; a bus adjustment unit connected between the plurality of bus masters and the memory, which limits the data transmission for a bus master whose memory bandwidth occupancy ratio obtained as a result of monitoring the operating statuses of the bus masters reaches a respective set memory bandwidth-limitation setting value; and a control unit which dynamically sets the calculated memory bandwidth-limitation setting value for each of the bus masters in the bus adjustment unit.

Note that also arbitrary combinations of the above-described constituents, and any exchanges of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a block diagram showing an example of a hardware structure of an image processing apparatus (ASIC) of an embodiment;

FIG. 2 is a block diagram showing an example of an internal structure of a bus adjustment unit of the embodiment;

FIG. 3 is a block diagram showing an example of an internal structure of a bandwidth-limitation storing unit of the embodiment;

FIG. 4 is a view showing an example of an internal structure of a bandwidth-limitation table of the embodiment;

FIG. 5 is a view showing an example of a bandwidth-limitation control of the embodiment;

FIG. 6 is a view showing an example of request signals of bus masters of the embodiment;

FIG. 7 is a flowchart showing an example of an image transmission control process of the embodiment; and

FIG. 8 is a flowchart showing an initialization process of the image processing apparatus of the embodiment.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

In this embodiment, a memory bandwidth of a memory is more effectively used to reduce the process time of the transmission in an image processing apparatus in which an engine transmission, an image processing transmission, a CPU transmission and an IO transmission are concentrated in the memory.

### (Entire Structure)

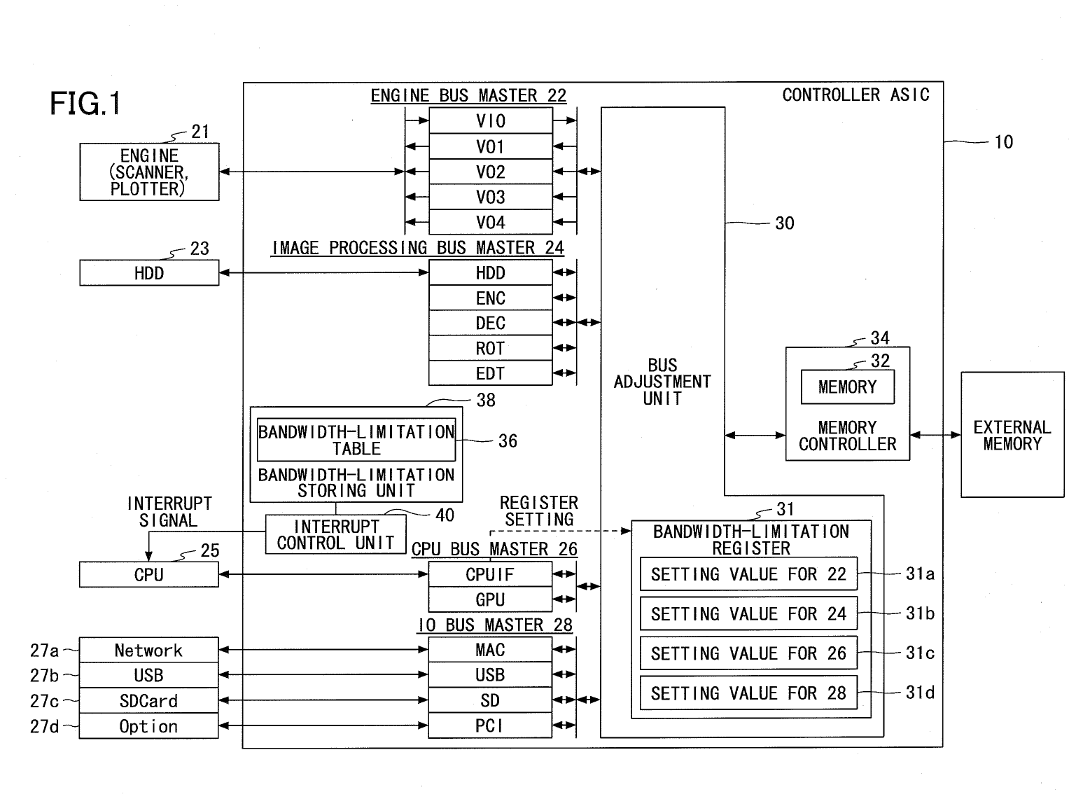

An example of an image processing apparatus of the embodiment is explained with reference to FIG. 1. The image processing apparatus (Application Specific Integrated Circuit (ASIC)) has a function to connect a plurality of bus masters with a memory, control data transmissions including transmission of image data to the memory, and inhibit data transmission under predetermined conditions.

FIG. 1 is a block diagram showing an example of a controller ASIC 10 included in the image processing apparatus of the embodiment. The image processing apparatus of the embodiment is exemplified as a printer or a scanner. The Application Specific Integrated Circuit (ASIC) means a custom Large Scale Integration (LSI) chip designed and manufactured for a specific calculation purpose and is called a custom chip as well.

The controller ASIC 10 includes a bus adjustment unit 30, a memory controller 34 including a memory 32, a bandwidth-limitation storing unit 38 including a bandwidth-limitation table 36, an interrupt control unit 40 and a plurality of bus masters (an engine bus master 22, an image processing bus master 24, a CPU bus master 26 and an IO bus master 28).

### (Bus Adjustment Unit)

The bus adjustment unit 30 is connected the plurality of bus masters and the memory 32, and adjusts data transmissions with the memory 32. In this embodiment, the controller ASIC 10 is configured to include the plurality of bus masters (multi bus master) each of which is capable of starting communication in the bus. In an apparatus having a single bus master function in which only a CPU is capable of starting communication of a bus, when the CPU does not access the bus during calculation or the like, for example, the bus is terminated. However, by providing the plurality of bus masters, data transmission is possible without using the function of the CPU to effectively use the bus. When the plurality of bus masters access the bus at the same time, the bus adjustment unit 30 adjusts the transmissions.

### (Group of Bus Masters)

In this embodiment, the plurality of bus masters transmit data to the memory 32 in the memory controller 34 via the bus adjustment unit 30. All of the data are transmitted from external to internal or internal to external via the memory 32.

The engine bus master 22, which is a bus master for engine transmission, is connected to an engine 21 such as a scanner, a plotter or the like. It is necessary for the engine bus master 22 to satisfy isochronous use for a line unit. For the engine transmission, a necessary memory bandwidth is determined by a mechanical requirement for reading/writing in the specific kind of the apparatus. Even when the necessary bandwidth is not ensured, the mechanical operation proceeds, to thus cause a generation of an abnormal image. In FIG. 1, the operating status of the engine bus master 22 is expressed by a combination of operating statuses “VI0”, “V01”, “V02”, “V03” and “V04”.

The image processing bus master 24, which is a bus master for image processing transmission, is connected to a HDD 23, and performs compressing and expanding or the like. It is necessary for the image processing bus master 24 to satisfy isochronous use for a page unit. For the image processing transmission, a necessary memory bandwidth is determined by a spec of speed (number of pages per minute) in the specific kind of the apparatus. Further, when an optional operation such as an image rotation or image editing which is not normally used is applied, the necessary memory bandwidth increases. When the necessary bandwidth is not ensured, the mechanical speed is lowered as an interval between pages in reading/writing is extended. In FIG. 1, the operating status of the image processing bus master 24 is expressed by a combination of operating statuses of “HDD”, “ENC”, “DEC”, “ROT” and “EDT”.

The CPU bus master 26, which is a bus master for CPU transmission, is connected to a Central Processing Unit (CPU) 25, a Graphics Processing Unit (GPU) or the like. The CPU bus master 26 determines a performance of the image processing apparatus. It is difficult to define the bandwidth necessary for the CPU transmission as the CPU transmission is performed by software. The CPU may require a large amount of memory bandwidth for prosecuting a heavy task. When the necessary bandwidth is not ensured, the speed of the apparatus is lowered. In FIG. 1, the operating status of the CPU bus master 26 is expressed by a combination of operating statuses “CPUIF” and “GPU”.

The Input Output (IO) bus master 28, which is a bus master for IO transmission is connected to a network 27a, a USB 27b, an SD card 27c and other optional functions (option 27d). The IO bus master 28 functions to actualize a transmission performance of an external interface IF. For the IO transmission, it is necessary to retain a necessary memory bandwidth in order not to cause an error in data transmission with an external device. When a large number of IO devices are connected, even when the necessary bandwidth for each of the devices is small, the necessary memory bandwidth becomes large. When the necessary bandwidth is not ensured, transmission performance of the external interface IF is lowered. In FIG. 1, the operating status of the IO bus master 28 is expressed by a combination of operating statuses “MAC”, “USB”, “SD”, and “PCI”.

Although partially not shown in FIG. 1, the CPU 25 is capable of accessing all of the registers in the controller ASIC 10 for register setting. Further, similarly, although not shown in FIG. 1, the operating statuses of all of the bus masters are input into the bandwidth-limitation table 36.

### (Bandwidth-Limitation by Bus Adjustment Unit)

The bus adjustment unit 30 includes counters corresponding to the bus masters where each counter counts data transmission of the respective bus master. Each of the counters measures the number of clocks in which data transmissions are performed among the last 1000 clocks, for a case that the last 1000 clocks are set as a measurement range. With this, the memory bandwidth occupancy ratio in data transmission can be calculated at an accuracy of **.* % for each of the bus masters.

The bus adjustment unit 30 includes bandwidth-limitation registers 31 corresponding to the bus masters. The CPU 25 is capable of setting a usable upper limit bandwidth for each of the bus masters in the respective bandwidth-limitation register 31. Specifically, in the bandwidth-limitation register 31, a bandwidth-limitation setting value 31a for the engine bus master 22, a bandwidth-limitation setting value 31b for the image processing bus master 24, a bandwidth-limitation setting value 31c for the CPU bus master 26, and a bandwidth-limitation setting value 31d for the 10 bus master 28 are set.

Thus, when the data transmission by one of the bus masters reaches the upper limit bandwidth of the memory based on the counted value of the transmission by the respective counter and the bandwidth-limitation setting value set in the respective bandwidth-limitation register 31, the bus adjustment unit 30 is configured not to receive a transmission request from the corresponding bus master. This limitation is continued until the counted value of the transmission by the respective counter becomes lower than the upper limit bandwidth of the memory.

### (Dynamic Control of Bus Adjustment Unit)

The CPU 25 controls such that a currently operated bus master is capable of effectively using a memory bandwidth while the other bus masters are not being operated or almost not being operated by dynamically controlling the bandwidth-limitation registers 31 in the bus adjustment unit 30. When the bus master which has not been operated is started to be operated, the CPU 25 controls the bandwidth-limitation setting value of each of the bus masters set in the bandwidth-limitation register 31 to be a normal bandwidth allocation. For example, when the “engine transmission” is not generated, the CPU 25 changes the bandwidth-limitation setting values 31a to 31d of the bus masters in the bandwidth-limitation registers 31 such that the bandwidth allocated for the engine transmission is effectively used by the “image processing transmission” or the “CPU transmission”. Thereafter, when the “engine transmission” is generated again, the CPU 25 sets back the bandwidth-limitation setting values 31a to 31d of the bus masters in the bandwidth-limitation registers 31 to be a normal bandwidth allocation to ensure the bandwidth for the “engine transmission”.

Generally, the CPU 25 controls the memory bandwidth by controlling the bandwidth-limitation registers by software. However, the software control by the CPU 25 is troublesome. Two examples of troublesome for the software control are explained in the following. First, combinations of the operating statuses of the bus masters are in proportion with 2 to the power of n where n is the number of bus masters. Thus, when a large number of bus masters are included, it is difficult to manage the bandwidth-limitation setting values in the bandwidth control registers for each of the combinations of the operating statuses of the bus masters. Second, the applications executed on a CPU such as copying, printing or the like do not rely on the activation of the bus masters. Thus, it is difficult to control the bandwidth-limitation registers by the application control by each software application.

In order to avoid the above trouble, in this embodiment, the bandwidth-limitation storing unit 38 including the bandwidth-limitation table 36 is provided on a circuit of the controller ASIC 10. The controller ASIC 10 controls the memory bandwidth by controlling the bandwidth-limitation register 31 by hardware based on the memory bandwidth-limitation setting values previously set in the bandwidth-limitation table 36.

Thus, the bandwidth-limitation table 36 stores bandwidth-limitation setting values in accordance with the operating statuses of all of the bus masters previously set by the CPU 25. The CPU 25 changes the bandwidth-limitation setting values of the bandwidth-limitation registers 31 in accordance with the operating statuses of the bus masters by referring to the bandwidth-limitation table 36. At this time, the interrupt control unit 40 generates an interrupt signal to the CPU 25. For the CPU 25, in order to actualize a high-speed response, the response to the interrupt signal is previously set with a higher priority. Thus, when the changing of the setting of the bandwidth-limitation registers 31 is requested by the interrupt signal, the CPU 25 reads out the bandwidth-limitation setting values stored in the bandwidth-limitation table 36 in accordance with the operating statuses of the plurality of bus masters, and sets the read bandwidth-limitation setting values in the bandwidth-limitation registers 31 of the bus adjustment unit 30 (register setting).

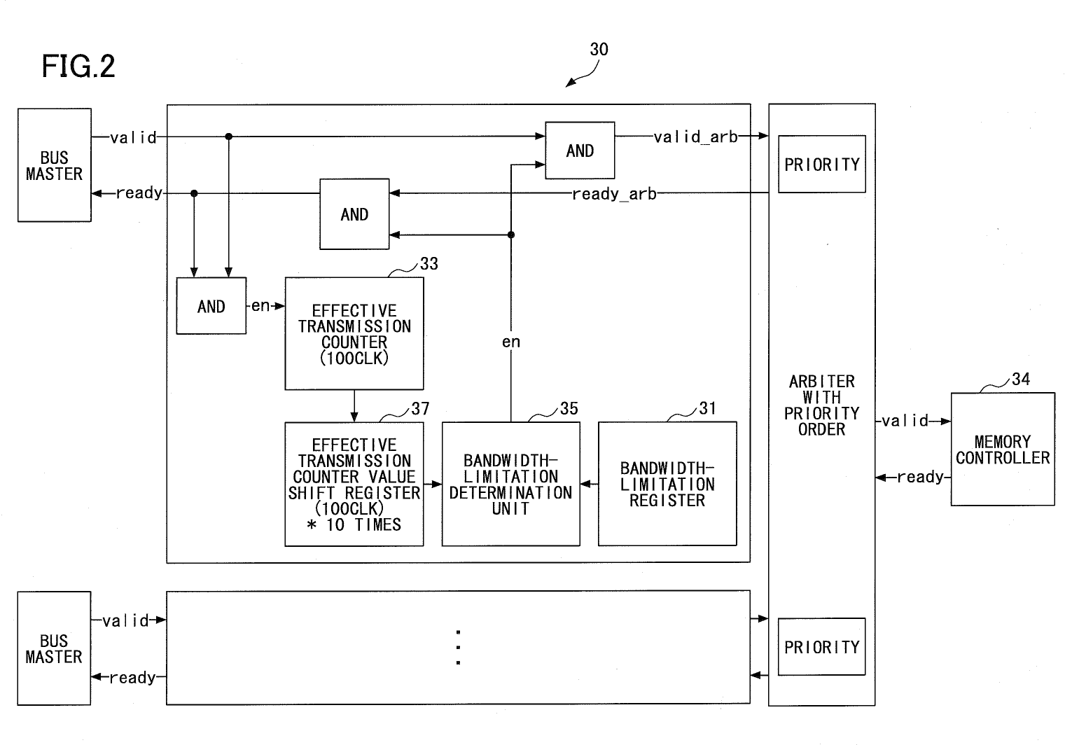

The bus adjustment unit 30 is explained in detail with reference to FIG. 2. FIG. 2 is a block diagram showing an example of an internal structure of the bus adjustment unit 30. The bus adjustment unit 30 includes a set of the bandwidth-limitation register 31, an effective transmission counter 33, a bandwidth-limitation determination unit 35 and an effective transmission counter value shift register 37 for each of the bus masters. As all of the sets have the same structure, one of the sets is explained in the following.

In the bandwidth-limitation register 31, the bandwidth-limitation setting value 31a for the engine bus master 22, the bandwidth-limitation setting value 31b for the image processing bus master 24, the bandwidth-limitation setting value 31c for the CPU bus master 26, or the bandwidth-limitation setting value 31d of the IO bus master, as shown in FIG. 1, is set by the CPU 25.

The effective transmission counter 33 counts data transmission for the respective bus master. In this embodiment, the effective transmission counter 33 counts the effective transmission clock number (it means a total of a requested clock number and an permitted clock number) among 100 clocks.

The effective transmission counter value shift register 37 (FIFO: First In First Out) stores the counted result of the last 10 times of the effective transmission clock number by the effective transmission counter 33.

The bandwidth-limitation determination unit 35 determines whether the bandwidth-limitation of the memory 32 is necessary. When it is determined that the bandwidth-limitation is necessary, the bandwidth-limitation determination unit 35 invalidates (masks) a data transmission request signal from the bus master side and a data transmission permission signal from the memory controller 34 side. With this, the transmission from the respective bus master is not performed. The bus adjustment unit 30 can obtain the current memory bandwidth occupancy ratio of the respective bus master by dividing the effective transmission clock number in the shift register by the total of 1000 clocks. In the bandwidth-limitation register 31, the bandwidth-limitation setting value is set, which corresponds to a set memory bandwidth occupancy ratio, to be used as a condition to determine whether the bandwidth-limitation of the memory 32 is necessary. When there is no limitation (when the bandwidth-limitation of the memory 32 is unnecessary), 100% may be set.

As such, the bus adjustment unit 30 calculates the current memory bandwidth occupancy ratio of each of the bus masters based on the monitored result of the operating statuses of the plurality of bus masters, and invalidates the data transmission of the respective bus master when the calculated current memory bandwidth occupancy ratio of each of the bus masters reaches the memory bandwidth-limitation setting value set by the CPU 25 in the respective bandwidth-limitation register 31.

As described above, by dynamically changing the memory bandwidth-limitation setting value for each of the bus masters set in the bus adjustment unit 30 in accordance with the operating status, the memory of the image processing apparatus can be more effectively used.

### (Bandwidth-Limitation Storing Unit/Bandwidth-Limitation Table)

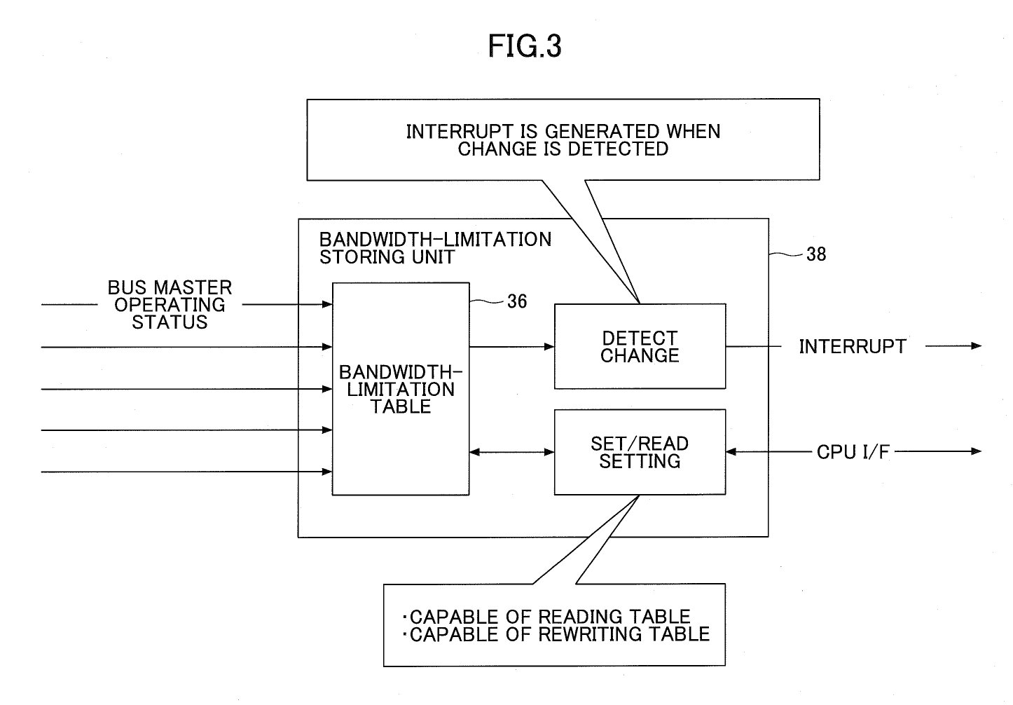

In this embodiment, as described above, the bandwidth-limitation storing unit 38 includes the bandwidth-limitation table 36. FIG. 3 is a block diagram showing an example of an internal structure of the bandwidth-limitation storing unit 38. An input signal for each of the bus masters indicating the respective bus master operating status is input to the bandwidth-limitation storing unit 38. For example, for the engine bus master 22, an input signal indicating operating statuses of “VI0”, “V01”, “V02”, “V03” and “V04” is continuously input to the bandwidth-limitation storing unit 38. The bandwidth-limitation storing unit 38 calculates (outputs) memory bandwidth-limitation setting values in accordance with the input signals indicating the operating statuses of the bus masters, respectively.

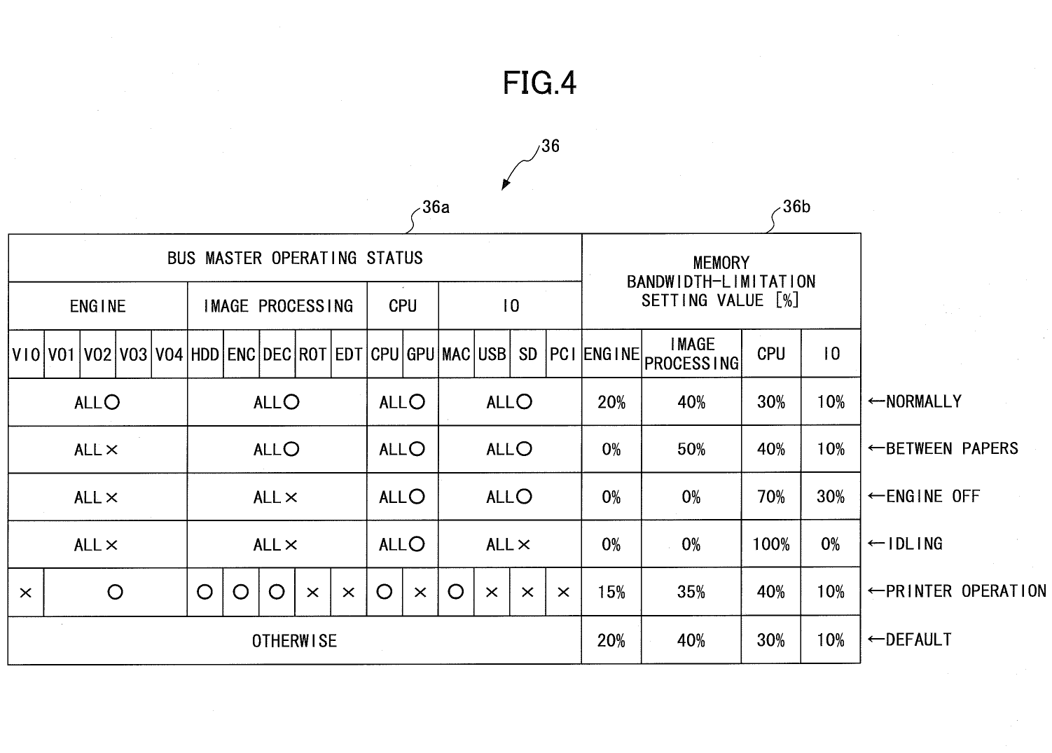

FIG. 4 is a view showing an example of information stored in the bandwidth-limitation table 36.

The bandwidth-limitation table 36 includes items such as a “bus master operating status 36a” and “memory bandwidth-limitation setting values 36b”. For the bus master operating status 36a, combinations of the operating statuses of the plurality of bus masters are stored. In other words, each of the combinations includes operating statuses of the plurality of the bus masters. For the memory bandwidth-limitation setting values 36b, combinations of the memory bandwidth-limitation setting values of the plurality of bus masters corresponding to the combinations of the operating statuses are stored, respectively. The memory bandwidth-limitation setting values 36b indicate the bandwidth-limitation setting values for the bus masters, respectively, while the total of the memory bandwidth is set as 100%.

Specifically, in FIG. 4, six combinations of the operating statuses of the plurality (4) of bus masters are exemplified.

For the first line, indicating the normal operation, the bandwidth-limitation setting values are; engine 20%, image processing 40%, CPU 30% and IO 10%. For the second line, indicating an operation between papers, the bandwidth-limitation setting values are; engine 0%, image processing 50%, CPU 40% and IO 10%. For the third line, indicating when engine is off, the bandwidth-limitation setting values are; engine 0%, image processing 0%, CPU 70% and IO 30%. For the fourth line, indicating when idling, the bandwidth-limitation setting values are; engine 0%, image processing 0%, CPU 100% and TO 0%. For the first line, indicating when performing printing operation, the bandwidth-limitation setting values are; engine 15%, image processing 35%, CPU 40% and IO 10%.

As the combinations of the operating statuses of the bus masters exist almost infinitely, default values for the bandwidth-limitation setting values 36b may be set. For example, in the last line of the bandwidth-limitation table 36 in FIG. 4, the bandwidth-limitation setting values 36b except for the cases shown in the above first line to the fifth line are set as the default values as follows. For the last line, indicating the default, the bandwidth-limitation setting values are; engine 20%, image processing 40%, CPU 30% and IO 10%. Here, the above described bandwidth-limitation setting values 36b are just an example and may have different values. Further, the bandwidth-limitation setting values 36b are able to be learned so that it is possible to change to more appropriate values in accordance with a result of learning for the memory bandwidth-limitation setting values 36b.

The bandwidth-limitation storing unit 38 obtains, based on the input signals as a result of monitoring, a combination of the operating statuses of the bus masters at the timing. Then, the bandwidth-limitation storing unit 38 calculates (obtains) the memory bandwidth-limitation setting values for the bus masters in accordance with the obtained combination of the current operating statuses by referring to the bandwidth-limitation table 36. When the bandwidth-limitation setting values for the corresponding combination of the current operating statuses are not stored, the bandwidth-limitation storing unit 38 calculates (obtains) the default values as the bandwidth-limitation setting values.

As such, the bandwidth-limitation storing unit 38 calculates (obtains) the bandwidth-limitation setting values in accordance with the combination of the current operating statuses of the bus masters and generates an interrupt when a change occurs in the obtained bandwidth-limitation setting values. Upon receiving the interrupt by the bandwidth-limitation storing unit 38, the interrupt control unit 40 sends the interrupt signal to the CPU 25.

Referring back to FIG. 1, the CPU 25 includes an interface I/F (register IF) of the CPU and reads out the calculated bandwidth-limitation setting values from the bandwidth-limitation table 36. Further, the CPU 25 is capable of writing initial data in the bandwidth-limitation table 36 for initialization.

Further, as an alternative example, in order to reduce the interrupt processing time or reading time of the bandwidth-limitation table 36 by the CPU 25, an access (register write access) for writing to the bandwidth-limitation registers 31 may be directly given to the interface I/F of the CPU 25 without the interruption. In this case, an interface I/F module of the CPU 25 (CPUIF) shown in FIG. 1 may include a mechanism to select a register access from the CPU 25 and a register access from the bandwidth-limitation storing unit 38.

Further, as an alternative example, the CPU 25 may write data in the bandwidth-limitation table 36 (table write) by burst transmission like a memory without writing data to the register (register write), when initializing the bandwidth-limitation table 36. With this, a time necessary for initializing the bandwidth-limitation table 36 can be reduced so that a time necessary until a user becomes able to use the image processing apparatus can be reduced.

Further, as an alternative example, in order to reduce the capacity of the bandwidth-limitation table 36, a mechanism to perform a lossless compression/expansion on data of the bus master operating status 36a and the memory bandwidth-limitation setting value 36b may be provided in the bandwidth-limitation storing unit 38. In this case, each of the combinations of the operating statuses of the plurality of bus masters may be stored in the bandwidth-limitation table 36 as being performed with the lossless compression. With this, the data amount of the bandwidth-limitation table 36 can be reduced so that the memory can also be reduced to lower the cost. Further, similarly, each of the combinations of the memory bandwidth-limitation setting values may be stored in the bandwidth-limitation table 36 as being performed with the lossless compression.

In this case, a monitored combination of the current operating statuses of the plurality of bus masters is compressed, the compressed combination of operating statuses stored in the bandwidth-limitation table 36 which matches the compressed monitored data is selected to obtain the corresponding compressed combination of the bandwidth-limitation setting values, and the obtained compressed combination of the bandwidth-limitation setting values is expanded to be sent to the CPU 25. In this case, the combinations of the operating statuses of the plurality of bus masters and the combinations of the bandwidth-limitation setting values of the plurality of bus masters may be compressed by the same compressing method or different compressing methods.

The CPU 25 is an example of a control unit which dynamically sets the memory bandwidth-limitation setting value of each of the bus masters calculated by the bandwidth-limitation storing unit 38 in the bus adjustment unit 30. The control unit may be a register access bus of the bus adjustment unit 30 capable of selecting a register access from the CPU 25 and a register access from the bandwidth-limitation storing unit 38. With this, as the process is performed by hardware, the processing speed for dynamically setting the memory bandwidth-limitation setting values in the bus adjustment unit 40 by the CPU 25 can be increased compared with the software control. With this, the performance of the apparatus can be improved.

### (Bandwidth-Limitation Control Considering Line Periodic Signal)

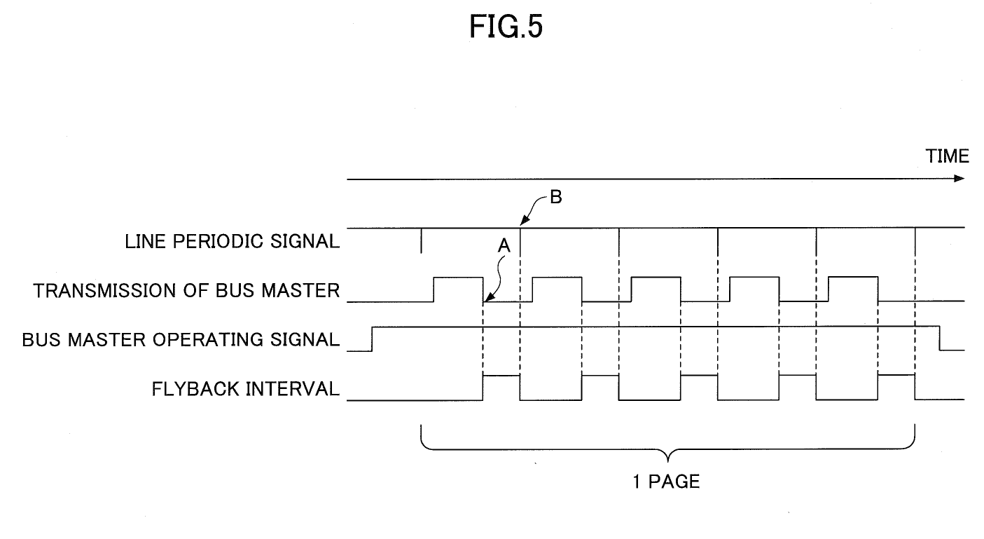

Next, as an alternative example, bandwidth-limitation control considering a line periodic signal is explained with reference to FIG. 5.

As the engine transmission repeats a line transmission in transmission of an image of 1 page, the transmission of the engine bus master 22 is not generated during a flyback interval. Thus, the bandwidth-limitation storing unit 38 may be provided with a function to detect the flyback interval of the engine transmission in which the transmission by the engine bus master 22 is not generated.

Specifically, an AND output of a period from an end time A of an 1 line transmission of the bus master to a start time B of the line periodic signal of the next line, and a bus master operating signal is obtained. With this, the flyback interval of the engine transmission in which the transmission of the engine bus master 22 is not generated is detected, and the detected signal is used in the bandwidth-limitation storing unit 38 as the bus master operating signal.

When the bus master operating signal is detected, the bandwidth-limitation storing unit 38 determines that the operating status of the engine bus master 22 as at OFF during the flyback interval of the line transmission by the engine bus master 22. With this, during the flyback interval of the engine transmission in which the transmission of the engine bus master 22 is not generated, the memory bandwidth ensured for the engine bus master 22 may be released to other bus masters to be used by the other bus masters to effectively use the memory. As a result, the processing speed of the entirety of the apparatus can be improved.

### (Image Transmission Operation)

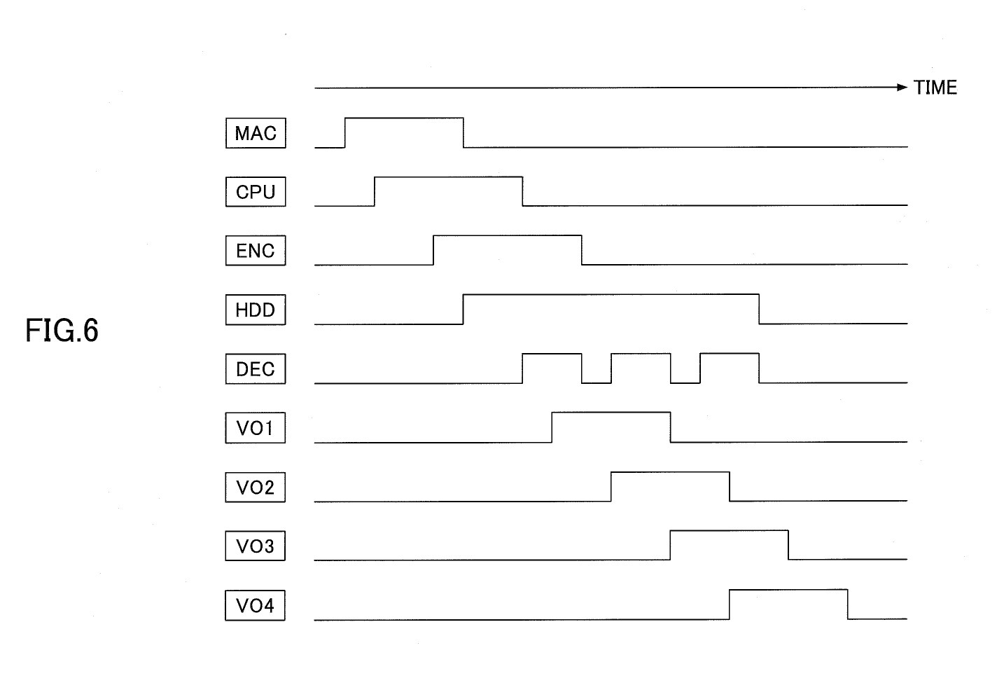

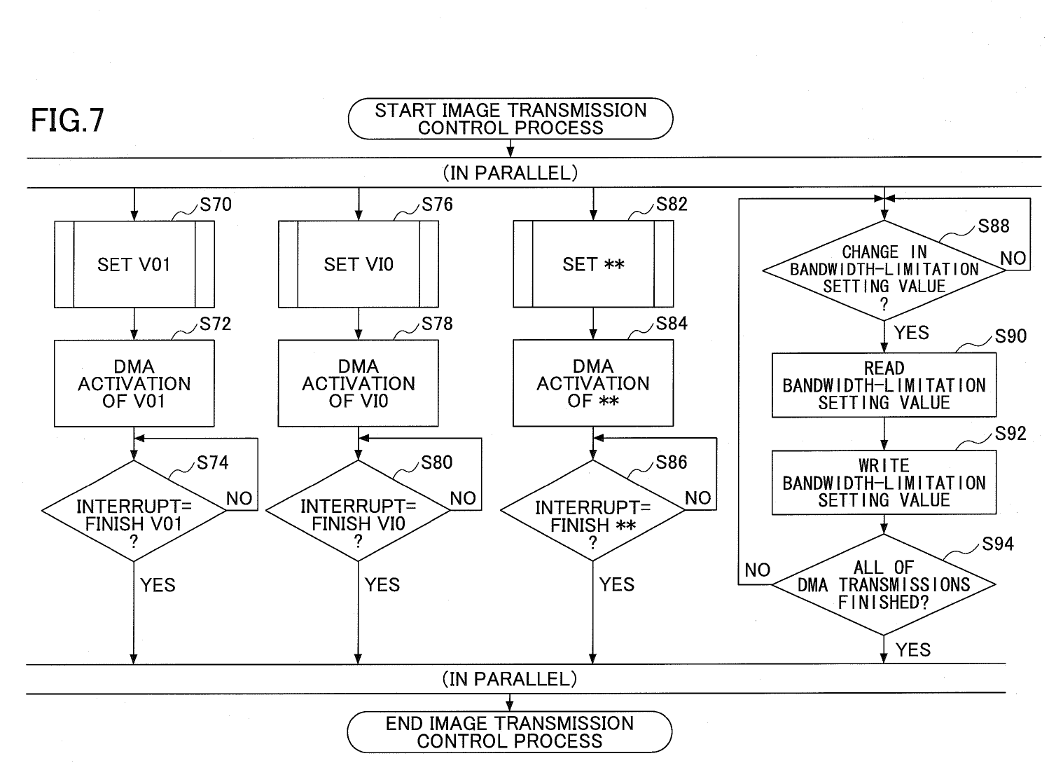

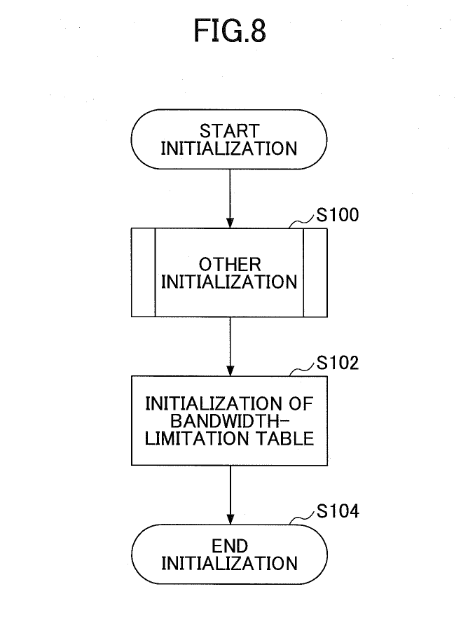

An operation of the image processing apparatus when image transmission is performed is explained with reference to FIG. 6 to FIG. 8. FIG. 6 is a view showing an example of request signals of the bus masters of the embodiment. FIG. 7 is a flowchart showing an example of an image transmission control process of the embodiment. FIG. 8 is a flowchart showing an initialization process of the image processing apparatus of the embodiment.

First, with reference to FIG. 6, an operation in which the image processing apparatus performs image transmission is briefly explained. When the image processing apparatus performs the image transmission, the CPU 25 activates the plurality of bus masters. Each of the activated bus masters reads data from the memory 32, performs a predetermined process to input data from outside and write in the memory 32, or output the data outside via the memory 32.

As data flows are generated in accordance with the process order, data transmission requests sent to the bus adjustment unit 30 from the bus masters are not always the same during a series of operations and vary as shown in FIG. 6, for example.

Next, with reference to FIG. 7, the image transmission control process is explained. When the image transmission control process is started, the CPU 25 initiates the plurality of bus masters, and processes control of each of the plurality of bus masters and control of the bus adjustment unit 30 in parallel. In FIG. 7, three lines in the left showing the control of the bus masters such as the V01, the VI0 and ** by the CPU 25 are shown, and the most right line shows the control of the bus adjustment unit 30 by the CPU 25.

The CPU 25 performs a normal activation and termination process of the bus masters and the control of the bus adjustment unit 30 in parallel. Specifically, after controlling the normal setting processes of the bus masters (S70, S76 and S82), the CPU 25 controls Direct Memory Access (DMA) activation processes (S72, S78 and S84), performs termination processes based on the interrupt signals (S74, S80, S86), and controls the bus adjustment unit 30 (S88, S90, S92 and S94) in parallel.

Control of the bus adjustment unit 30 (S88, S90, S92 and S94) is explained. The bandwidth-limitation storing unit 38 continuously monitors the operating statuses of the bus masters (see FIG. 3), and generates an interrupt when the bandwidth-limitation setting value calculated based on the bandwidth-limitation table 36 is varied.

When the bandwidth-limitation setting value is varied and the interrupt signal is generated (YES in step S88), the CPU 25 reads the bandwidth-limitation setting values calculated based on the bandwidth-limitation table 36 from the bandwidth-limitation table 36 (step S90), and writes the read bandwidth-limitation setting values in the bandwidth-limitation register 31 of the bus adjustment unit 30 (step S92). The CPU 25 determines whether all of the DMA transmissions are finished (step S94), and repeats the steps S88, S90, S92 and S94 until all of the DMA transmissions are finished. When all of the DMA transmission are completed (YES in step S94), the image transmission control process is finished. With this, the CPU 25 can perform the interrupt processes with a high speed.

The bus adjustment unit 30 limits the data transmissions from each of the bus masters based on the bandwidth-limitation setting values newly set in the bandwidth-limitation registers 31, respectively.

With reference to FIG. 8, the CPU 25 initializes the bandwidth-limitation table 36 when initializing the system when the power is switched on or when recovering to an energy saving mode. After performing a normal initialization (S100), the CPU 25 initializes the bandwidth-limitation table 36 (S102). Data for the initialization is stored in a non-volatile medium such as a ROM, a HDD or the like, and the CPU 25 reads the data to set in the bandwidth-limitation table 36. As such, when the CPU 25 initializes the bandwidth-limitation table 36, the CPU 25 is capable of performing DMA transmission of the memory bandwidth-limitation setting values of the bus masters from a memory area. With this, the initialization time for the bandwidth-limitation table 36 can be shortened.

As described above, the image processing apparatus of the embodiment includes the bandwidth-limitation table 36, the bandwidth-limitation storing unit 38, the bandwidth-limitation function of the bus adjustment unit 30, and the function of the bandwidth-limitation setting control always being performed by the CPU 25. Then, the image processing apparatus of the embodiment includes the following feature in setting the bandwidth-limitation setting values, which indicate conditions for the bandwidth-limitation of each of the bus masters in the bus adjustment unit 30, in the bandwidth-limitation registers 31.

The bus adjustment unit 30 stores the bandwidth-limitation setting values of the bus masters corresponding to the combination of the current operating statuses of the bus masters in the respective values of the bandwidth-limitation register 31. The operating statuses of the plurality of bus masters are always being monitored and when it is determined to be necessary to change the bandwidth-limitation setting values in accordance with the operating statuses of the plurality of bus masters, the bandwidth-limitation setting values set in the bandwidth-limitation registers 31 are dynamically changed.

With this, the usable bandwidth of the memory 32 becomes always near 100%, and the bandwidth occupancy ratio can be always maintained at or near 100%. Thus, the process speed of the image processing apparatus can be improved, the operational response can be improved, and the transmission speed of the external device can be improved so that usability for a user of the image processing apparatus can be also improved.

### (Alternative Example)

An alternative example is explained. In the alternative example of the above embodiment, the bandwidth-limitation storing unit 38 may store priority information of the bus masters in the bandwidth-limitation table 36. At this time, the bus adjustment unit 30 may adjust the memory bandwidth limitation such that the data transmission of the bus master with a higher priority is given a priority compared with the data transmission of the bus master with a lower priority based on the priority information stored in the bandwidth-limitation table 36. With this, the priority order can be changed in accordance with the operating statuses of the bus masters so that the transmission performance of the devices can be appropriately improved such as, generally, the transmission performance of the device with a lower priority can be improved, or the like.

Although a preferred embodiment of the image processing apparatus has been specifically illustrated and described, it is to be understood that minor modifications may be made therein without departing from the spirit and scope of the invention as defined by the claims.

The present invention is not limited to the specifically disclosed embodiments, and variations and modifications may be made without departing from the scope of the present invention.

For example, the bandwidth-limitation table 36 may be stored in the bandwidth-limitation storing unit 38 as explained above, or may be stored in a unit other than the bandwidth-limitation storing unit 38. Further, the information of the bandwidth-limitation table may be stored in a memory area within the ASIC, or may be stored in a memory area outside the ASIC.

Further, each of the bus masters may lower a burst length to request from the respective bus master when the bandwidth-limitation setting value of the memory set in the bus adjustment unit 30 of the respective bus master is lower than the default value. With this, the remaining memory bandwidth can be more evenly shared by the plurality of the bus masters when the bandwidth allocated for each of the bus masters is lowered. Thus, a case in which only a specific bus master uses an excessive amount of the memory bandwidth can be prevented to avoid an extreme degradation in performance.

Further, each of the bus masters may lower the upper limit of the request number (outstanding request number) to request from the respective bus master than the default value when the bandwidth-limitation setting value of the memory set in the bus adjustment unit 30 of the respective bus master is lower than the default value. With this as well, the remaining memory bandwidth can be more evenly shared by the plurality of the bus masters when the bandwidth allocated for each of the bus masters is lowered. Thus, a case in which only a specific bus master uses an excessive amount of the memory bandwidth can be prevented to avoid an extreme degradation in performance.

The programs for actualizing the functions executed by the CPU 25 may be previously stored in a storing unit of a computer, not shown in the drawings, such as a ROM, a HDD or the like. Alternatively, the programs may be stored in a recording medium such as a CD-ROM, or in a non-volatile recording medium (memory) such as a flexible disc, an EEPROM, a memory card or the like, and may be installed in the computer after being read from the recording medium to be performed by the CPU 25, or read by the CPU 25 from the recording medium to be executed. Further alternatively, the programs may be downloaded from an external device connected to a network and including a recording medium which stores the programs or an external device connected to a network and including a storing unit which stores the programs.

According to the embodiment, the memory bandwidth-limitation setting values of the plurality of bus masters can be dynamically set to effectively use the memory of the image processing apparatus.

The present application is based on Japanese Priority Application No. 2012-066677 filed on Mar. 23, 2012, the entire contents of which are hereby incorporated by reference.

What is claimed is:

1. An image processing apparatus capable of controlling data transmission including image data between a plurality of bus masters and a memory, comprising:
a bandwidth-limitation storing unit which calculates a memory bandwidth-limitation setting value for each of the bus masters corresponding to the combination of the operating statuses of the bus masters obtained as a result of monitoring the operating statuses of the bus masters based on a bandwidth-limitation table which stores memory bandwidth-limitation setting values of the bus masters, respectively, for each of the combinations of the operating statuses of the bus masters;
a bus adjustment unit connected between the plurality of bus masters and the memory, which limits the data transmission for a bus master whose memory bandwidth occupancy ratio obtained as a result of monitoring the operating statuses of the bus masters, reaches a respective set memory bandwidth-limitation setting value; and
a control unit which dynamically sets the calculated memory bandwidth-limitation setting value for each of the bus masters in the bus adjustment unit.

2. The image processing apparatus according to claim 1,
wherein the control unit is a register access bus of the bus adjustment unit capable of selecting a register access from a CPU and a register access from the bandwidth-limitation storing unit.

3. The image processing apparatus according to claim 1,
wherein the control unit is configured to perform burst transmission when initializing the bandwidth-limitation table.

4. The image processing apparatus according to claim 1,
wherein the plurality of bus masters include a bus master for engine transmission, and
the bandwidth-limitation storing unit determines that the operating status of the bus master for engine transmission is off in a flyback interval.

5. The image processing apparatus according to claim 1,
wherein the combination of the operating statuses of the bus masters stored in the bandwidth-limitation table are in a state of being performed with lossless compression.

6. The image processing apparatus according to claim 1,
wherein the compression coded bandwidth-limitation setting values stored in the bandwidth-limitation table are in a state of being performed with lossless compression.

7. The image processing apparatus according to claim 1,
wherein when initializing the bandwidth-limitation table, the control unit transmits the memory bandwidth-limitation setting values of the bus masters to the bandwidth-limitation table from another memory area by a direct memory access.

8. The image processing apparatus according to claim 1, wherein
the bandwidth-limitation storing unit stores priority information for each of the bus masters in the bandwidth-limitation table, and
the bus adjustment unit is configured to give a priority to the data transmission of the bus master with a higher priority to the data transmission of the bus master with a lower priority based on the priority information stored in the bandwidth-limitation table.

9. The image processing apparatus according to claim 1,
wherein a default value of the memory bandwidth-limitation setting value for each of the bus masters is stored in the bandwidth-limitation table, and
each of the bus masters lowers a burst length to request from the respective bus master when the memory bandwidth-limitation setting value set in the bus adjustment unit is lower than the default value.

10. The image processing apparatus according to claim 1,
wherein a default value of the memory bandwidth-limitation setting value for each of the bus masters is stored in the bandwidth-limitation table, and
each of the bus masters lowers the upper limit of a request number to request from the respective bus master when the memory bandwidth-limitation setting value set in the bus adjustment unit is lower than the default value.
